(19) United States
(12) Patent Application Publication
(10) Pub. No.: US 2012/0275565 A1
(43) Pub. Date: Nov. 1, 2012

(54) METHOD OF DETECTING RADIATION SIGNALS FROM RADIATIONS IN DIFFERENT ENERGY BANDS AND APPARATUS THEREFOR

(75) Inventors: Sung-su Kim, Yongin-si (KR); Myung-jin Chung, Seoul (KR); Hyun-hwa Oh, Hwaseong-si (KR); Young-hun Sung, Hwaseong-si (KR); Sang-wook Han, Busan (KR); Jae-hyun Kwon, Hwaseong-si (KR); Seok-min Han, Seongnam-si (KR); Dong-goo Kang, Yongin-si (KR); Kang-eui Lee, Yongin-si (KR)

(73) Assignees: SAMSUNG LIFE PUBLIC WELFARE FOUNDATION, SAMSUNG MEDICAL CENTER, Seoul (KR); SAMSUNG ELECTRONICS CO., LTD., Suwon-si (KR)

(21) Appl. No.: 13/457,575

(22) Filed: Apr. 27, 2012

(30) Foreign Application Priority Data
Apr. 29, 2011 (KR) 10-2011-0040965

(51) Int. Cl. G01N 23/083

(52) U.S. Cl. 378/62

(57) ABSTRACT

A radiation signal detection apparatus includes a filter unit configured to allow penetration of a component of radiation that passed through a subject, the filter unit including one or more unit filters configured to allow penetration of only a component in a predetermined energy band of the radiation, and a sensor unit, including one or more first unit sensors configured to convert only the component of the radiation for which the penetration is allowed by the unit filters into a first electric signal, one or more second unit sensors configured to convert a component in all energy bands of the radiation into a second electric signal, and a radiation signal detector configured to detect a first radiation signal and a second radiation signal by respectively using the first electric signal of the first unit sensors and the second electric signal of the second unit sensors.

### CROSS-REFERENCE TO RELATED APPLICATIONS

This application claims the benefit under 35 U.S.C. § 119(a) of Korean Patent Application No. 10-2011-0040965, filed on Apr. 29, 2011, in the Korean Intellectual Property Office, the disclosure of which is incorporated herein by reference for all purposes.

### BACKGROUND

1. Field

The following description relates methods of detecting a radiation signal and apparatuses therefor.

2. Description of the Related Art

A medical image system using radiation, for example, an X-ray, obtains a radiation image from an X-ray that passes through a subject, such as a human body, by irradiating the X-ray to the subject. A degree of the X-ray being absorbed by the subject is different according to the type or density of the subject, or an energy band of the X-ray. For example, an absorption coefficient of the X-ray to a bone is very high compared to that of soft tissues. Accordingly, a contrast between the soft tissues and the bone is high, and, as a result, the soft tissues and the bone are clearly distinguishable from each other in the radiation image. However, the soft tissues may include a variety of tissues that have a similar absorption coefficient to an X-ray in a single energy band, and, thus, a similar intensity as displayed in the radiation image. Therefore, it may be difficult to differentiate types of tissues displayed amongst the soft tissues in the radiation image.

### SUMMARY

In one general aspect, there is provided a radiation signal detection apparatus, including a filter unit configured to allow penetration of a component of radiation that passed through a subject, the filter unit including one or more unit filters configured to allow penetration of only a component in a predetermined energy band of the radiation, and a sensor unit, including one or more first unit sensors configured to convert only the component of the radiation for which the penetration is allowed by the unit filters into a first electric signal, one or more second unit sensors configured to convert a component in all energy bands of the radiation into a second electric signal, and a radiation signal detector configured to detect a first radiation signal and a second radiation signal by respectively using the first electric signal of the first unit sensors and the second electric signal of the second unit sensors.

A general aspect of the radiation signal detection apparatus may further provide that the first radiation signal has characteristics that differ from characteristics of the second radiation signal.

A general aspect of the radiation signal detection apparatus may further provide that a light-receiving area of the first unit sensors is greater than a light-receiving area of the second unit sensors.

A general aspect of the radiation signal detection apparatus may further provide that the unit filters are arranged such that spaces are formed throughout the filter unit, the spaces allowing the penetration of the radiation from which the second radiation signal is detected.

A general aspect of the radiation signal detection apparatus may further provide that the filter unit further includes one or more other unit filters, each of the other unit filters being configured to allow penetration of only a component in an other predetermined energy band of the radiation, the sensor unit further includes one or more third unit sensors configured to convert only the component of the radiation for which the penetration is allowed by the other unit filters into a third electric signal, and the radiation signal detector is further configured to detect a third radiation signal using the third electric signal of the third unit sensors.

A general aspect of the radiation signal detection apparatus may further provide that the other predetermined energy band differs from the predetermined energy band.

A general aspect of the radiation signal detection apparatus may further provide that the third radiation signal has characteristics that differ from the characteristics of the first radiation signal and the second radiation signal.

A general aspect of the radiation signal detection apparatus may further provide that the unit filters and the other unit filters are arranged such that spaces are formed throughout the filter unit, the spaces allowing the penetration of the radiation from which the second radiation signal is detected.

A general aspect of the radiation signal detection apparatus may further provide that a material that forms the unit filters differs from a material that forms the other unit filters.

A general aspect of the radiation signal detection apparatus may further provide that a thickness of the unit filters is greater than a thickness of the other unit filters.

In another aspect, there is provided a radiation signal detection apparatus, including a filter unit, including one or more first unit filters configured to allow penetration of only a first component, the first component being in a predetermined energy band of radiation that passed through a subject, and one of more second unit filters configured to allow penetration of only a second component, the second component being in a different energy band of the radiation from the predetermined energy band, and a sensor unit, including one or more first unit sensors configured to convert only the component of the radiation for which the penetration is allowed by the first unit filters into a first electric signal, one or more second unit sensors configured to convert only the component of the radiation for which the penetration is allowed by the second unit filters into a second electric signal, and a radiation signal detector configured to detect a first radiation signal and a second radiation signal by respectively using the first electric signal of the first unit sensors and the second electric signal of the second unit sensors.

A general aspect of the radiation signal detection apparatus may further provide that the first radiation signal has characteristics that differ from characteristics of the second radiation signal.

A general aspect of the radiation signal detection apparatus may further provide that a light-receiving area of the first unit sensors is greater than a light-receiving area of the second unit sensors.

A general aspect of the radiation signal detection apparatus may further provide that a material that forms the first unit filters differs from a material that forms the second unit filters.

A general aspect of the radiation signal detection apparatus may further provide that a thickness of the first unit filters is greater than a thickness of the second unit filters.

In another aspect, there is provided a method of detecting radiation signals, the method including receiving one or more first electric signals output from one or more first unit sensors, the first electric signals corresponding to a component in a predetermined energy band of radiation that passed through a subject, receiving one or more second electric signals output from one or more second unit sensors, the second electric signals corresponding to a component in all energy bands of the radiation, detecting a first radiation signal by using the first electric signals, and detecting a second radiation signal by using the second electric signals.

A general aspect of the method may further provide that a light-receiving area of the first unit sensors is greater than a light-receiving area of the second unit sensors.

A general aspect of the method may further provide receiving one or more third electric signals output from one or more third unit sensors, the third electric signals corresponding to a component in an other energy band of the radiation, the other energy band of the radiation being different from the predetermined energy band of the radiation, and detecting a third radiation signal by using the third electric signals.

In another aspect, there is provided a method of detecting radiation signals, the method including receiving one or more first electric signals output from one or more first unit sensors, the first electric signals corresponding to a component in a first energy band of radiation that passed through a subject, receiving one or more second electric signals output from one or more second unit sensors, the second electric signals corresponding to a component in a second energy band of the radiation, the second energy band being different from the first energy band, detecting a first radiation signal by using the first electric signals, and detecting a second radiation signal by using the second electric signals.

A general aspect of the method may further provide that a light-receiving area of the first unit sensors is greater than a light-receiving area of the second unit sensors.

Other features and aspects may be apparent from the following detailed description, the drawings, and the claims.

### BRIEF DESCRIPTION OF THE DRAWINGS

FIG. 1 is a diagram illustrating an example of a medical image system.

FIG. 2 is a graph illustrating an example showing of an energy spectrum of radiation generated from a radiation generator.

FIG. 3 is a diagram illustrating an example of a radiation signal detection apparatus of the medical image system example of FIG. 1.

FIG. 4 is a diagram illustrating an example of a filter unit and a sensor unit of the radiation signal detection apparatus example illustrated in FIG. 3.

FIG. 5 are graphs illustrating example showings of energy spectrums of radiation generated from a radiation generator, and predetermined energy bands selected by a unit filter.

FIG. 6 are diagrams illustrating examples of a unit filter, a space, a unit sensor A, and a unit sensor B of the radiation signal detection apparatus example illustrated in FIG. 3.

FIG. 7 is a diagram illustrating another example of a radiation signal detection apparatus.

FIG. 8 is a diagram illustrating yet another example of a radiation signal detection apparatus.

FIG. 9 are diagrams illustrating examples of a unit filter A, a space, a unit filter C, a unit sensor A, a unit sensor B, and a unit sensor C of the radiation signal detection apparatus example illustrated in FIG. 8.

FIG. 10 is a flowchart illustrating an example of a method of detecting radiation signals.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. In addition, descriptions of well-known functions and constructions may be omitted for increased clarity and conciseness.

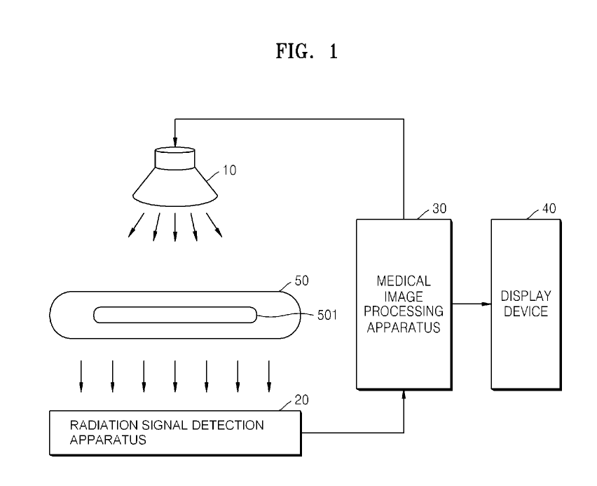

FIG. 1 is a diagram illustrating an example of a medical image system. Referring to FIG. 1, the medical image system includes a radiation generator 10, a radiation signal detection apparatus 20, a medical image processing apparatus 30, and a display device 40. The radiation generator 10 generates radiation. Radiation is an assembly of energy having a form of particles or electromagnetic waves. The radiation particles or electromagnetic waves are emitted when an unstable radioactive nuclide is changed to a stable nuclide. Examples of radiation are electromagnetic waves used for broadcasting communication, infrared rays, and visible rays, ultrasonic waves, alpha rays, beta rays, gamma rays, X-rays, and neutron rays. Radiation emitted in X-rays may harm the human body through the generation of an ionization phenomenon. For convenience of description, radiation described herein denotes radiation emitted through X-rays. However, it is obvious to one of ordinary skill in the art that radiation may be emitted from sources other than X-rays.

Radiation is generated in the form of radiant rays that have strong penetrating power. The radiant rays are generated when electrons quickly collide with a subject 50. Accordingly, the radiation generator 10 includes an anode and a cathode, and generates radiation by colliding electrons with a surface of the anode, the electrons being generated by a filament of the cathode heated by a high voltage.

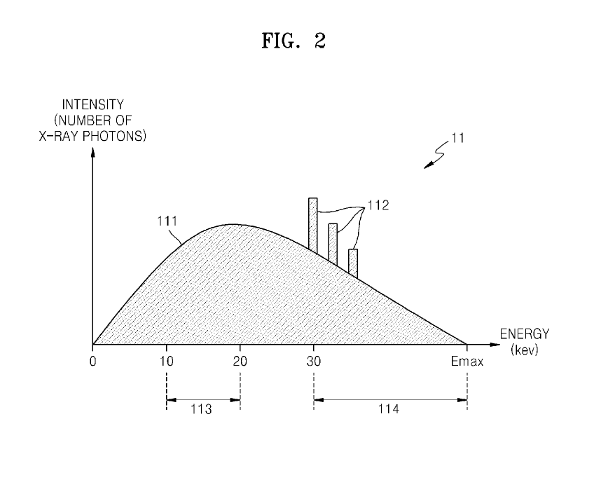

FIG. 2 is a graph illustrating an example showing of an energy spectrum 11 of radiation generated by the radiation generator 10. The energy spectrum 11 of FIG. 2 shows the intensity of the radiation according to a change of energy. For example, a unit of radiation energy is keV, and a unit of intensity is a number of radiation photons. In other words, the energy spectrum 11 shows a difference between the number of radiation photons according to the radiation energy. Referring to FIG. 2, the energy spectrum 11 of the radiation generated by the radiation generator 10 may be represented by a combination of a continuous distribution 111 according to Bremsstrahlung, and a discontinuous distribution 112 according to a characteristic radiation. The discontinuous distribution 112 may occur during a transit of an outer electron at a position of electrons. Generally, a component in a high energy band of radiation has higher penetrating power than a component in a low energy band. The quality of a radiation image is not determined only by an energy band of radiation, penetrating power, or radiation intensity. However, since the radiation image shows different characteristics according to energy bands of radiation, the quality of the radiation image may be improved by using radiation images generated from a multi-energy band together.

Referring to FIG. 2, a radiation band denotes a range of energy determined by the upper limit and the lower limit of the energy of the radiation. For example, a band 113 may be an energy band of radiation in the range from approximately 10 keV to approximately 20 keV, and a band 114 may be an energy band of radiation in the range from approximately 30 keV to approximately Emax. As described above, since a radiation signal detected from the band 113 and a radiation signal detected from the band 114 have different characteristics, a radiation image generated from the radiation signal detected from the band 113 and a radiation image generated from the radiation signal detected from the band 114 may also have different image characteristics.

Referring back to FIG. 1, the radiation signal detection apparatus 20 detects radiation signals having various characteristics from radiation that is generated by the radiation generator 10 and passes through a subject 50. For example, the subject 50 may be a patient. However, it would be obvious to one of ordinary skill in the art that the subject 50 is not limited to a patient, and may be any object of an image, such as a living organism or a thing. Radiation that passes through the subject 50 is a transmit radiation from among primary radiation generated by the radiation generator 10. The primary radiation, except for the transmit radiation, may be an absorption radiation absorbed by the subject 50, a scattering radiation that is scattered after passing through the subject 50, and radiation emitted as heat energy.

Generally, radiation that passes through the subject 50 is a type of ray. The radiation signals are detected from an electric signal measured in correspondence to an intensity of the ray. For example, a device inside the radiation signal detection apparatus 20 may receive radiation that passes through the subject 50. The radiation signal detection apparatus 20 may measure an electric signal corresponding to the radiation received by the device in order to generate the radiation signal. The device inside the radiation signal detection apparatus 20 may be a photodiode, but is not limited thereto.

Generally, the radiation signals are generated from components in different energy bands of the radiation that passed through the subject 50. Assuming that the energy spectrum 11 of FIG. 2 is an energy spectrum of the radiation that passed through the subject 50, one of the radiation signals is detected from the component in the band 113 of the radiation in the range from approximately 10 keV to approximately 20 keV, and another of the radiation signals is detected from the component in the band 114 of the radiation in the range from approximately 30 keV to approximately Emax. Thus, one radiation signal has different characteristics from another radiation signal. Further, yet another radiation signal detected from a component of any energy band may have different characteristics from the above-referenced radiation signals.

The medical image processing apparatus 30 generates radiation images by using the radiation signals received from the radiation signal detection apparatus 20. The medical image processing apparatus 30 generates a radiation image from one of the radiation signals. Generally, the radiation signal includes a difference of intensities of the radiation input to the radiation signal detection apparatus 20, according to penetrating power or absorption difference of radiation in tissues of the subject 50. For example, from among radiation generated by the radiation generator 10, a component that passes through a tissue 501 of the subject 50 and a component that passes through a portion other than the tissue 501 have different intensities, and such a difference is shown in the radiation signals. The medical image processing apparatus 30 generates the radiation image of the subject 50 based on such a difference. Generally, the radiation signal detection apparatus 20 is formed of an array of unit sensors, thereby aiding in effectively detecting the difference of intensities of the radiation input to the radiation signal detection apparatus 20, according to the penetrating power or absorption difference in the tissues of the subject 50. It would be obvious to one of ordinary skill in the art that the array of unit sensors may be a 1-dimensional (1D) array, a 2D array, or a 3D array.

The medical image processing apparatus 30 generates the radiation image from a different radiation signal from among the radiation signals. For example, the medical image processing apparatus 30 may generate a radiation image from any one of the radiation signals, and a different radiation image from another one of the radiation signals. As described above, the one radiation signal and the other radiation signal have different characteristics due to a difference of energy bands of the radiation. Accordingly, the radiation image and the different radiation image have different image characteristics. For example, if the subject 50 is a breast of a patient, each soft tissue, such as a microcalcification tissue, a glandular tissue, an adipose tissue, a mass, and a fibrous tissue, has different absorption coefficients according to energy bands of the radiation. Thus, the difference of the absorption coefficients enables generation of radiation images having different characteristics according to energy bands.

The apparatus 30 generates the radiation images based on the radiation signals received from the radiation signal detection apparatus 20. Generally, the apparatus 30 may be formed of one or more processors to generate the radiation images. A processor may be realized in an array of logic gates, or in a combination of a general-purpose microprocessor and a memory storing a program executable by the general-purpose microprocessor. However, the processor may be realized in a different form of hardware.

The display device 40 displays the radiation images generated by the medical image processing apparatus 30. For example, the display device 40 includes an output device, such as a display panel, a touch screen, or a monitor, and a software module for driving the output device. The display device 40 is included in the medical image system.

In addition, the medical image system may further include a communication device that transmits the radiation images generated by the medical image processing apparatus 30 to an external device, and receives data from the external device. For example, the external device may be another medical image system disposed at a remote place, a general-purpose computer system, a facsimile, or the like. The communication device may transmit and receive data to and from the external device through a wired or wireless network. For example, a network may be the Internet, a local area network (LAN), a wireless LAN, a wide area network (WAN), or a personal area network (PAN), but is not limited thereto, and may be any network that is capable of transmitting and receiving information. In addition, the medical image system may further include a storage device that enables the storage of the radiation images generated by the medical image processing apparatus 30. For example, the storage device may be a hard disk drive (HDD), a read only memory (ROM), a random access memory (RAM), a flash memory, or a memory card. As such, the medical image system generates the radiation images from the radiation signals in various energy bands, and displays, stores, and transmits the radiation images, thereby providing an accurate medical image to a patient or a medical expert.

An example of the radiation signal detection apparatus 20 will now be described.

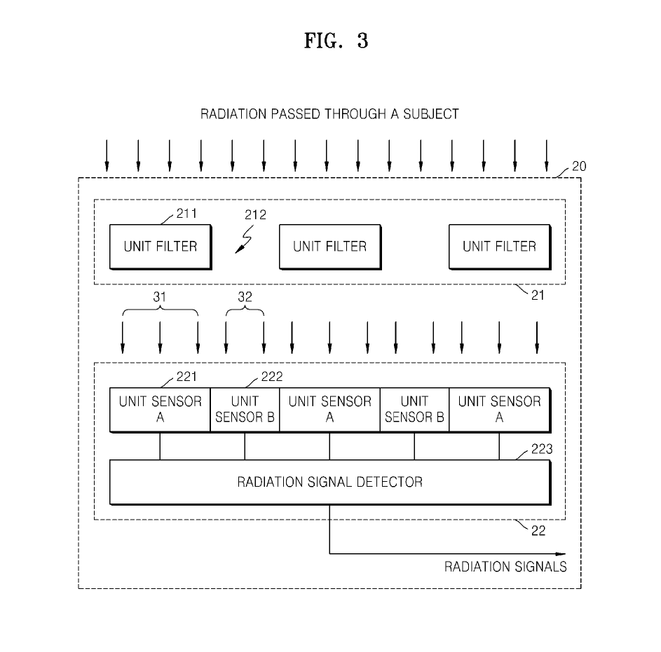

FIG. 3 is a diagram illustrating an example of the radiation signal detection apparatus 20 of the medical image system example of FIG. 1. Referring to FIG. 3, the radiation signal detection apparatus 20 includes a filter unit 21 and a sensor unit 22. However, the structure of the radiation signal detection apparatus 20 of FIG. 3 is only an example and it would be obvious to one of ordinary skill in the art that the structure may be modified based on the elements of FIG. 3.

The filter unit 21 includes a plurality of unit filters. For example, a unit filter 211 from among the plurality of unit filters selectively allows only a component in a predetermined energy band from radiation that passes through the subject 50 to penetrate.

The filter unit 21 may include a space 212 between the unit filters including at least the unit filter 211. Accordingly, the filter unit 21 may generate a difference between an energy band of radiation 31 that passes through the unit filter 211 from among the radiation that is generated by the radiation generator 10 and passed through the subject 50, and an energy band of radiation 32 that passes through the space 212 from among the radiation that is generated by the radiation generator 10 and passed through the subject 50. For example, radiation 31 in the predetermined energy band from among the radiation that is generated by the radiation generator 10 and passed through the subject 50 may selectively pass through the unit filter 211, and radiation 32 in all energy bands of the radiation that is generated by the radiation generator 10 and passed through the subject 50 may pass through the space 212.

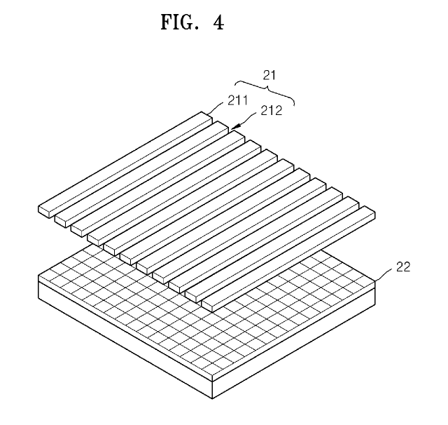

FIG. 4 is a diagram illustrating an example of the filter unit 21 and the sensor unit 22. As shown in FIG. 4, the filter unit 21 includes the unit filter 211 and other unit filters, and a plurality of spaces as the space 212. However, the filter unit 21 of FIG. 4 is only an example, and may have any structure including unit filters and spaces.

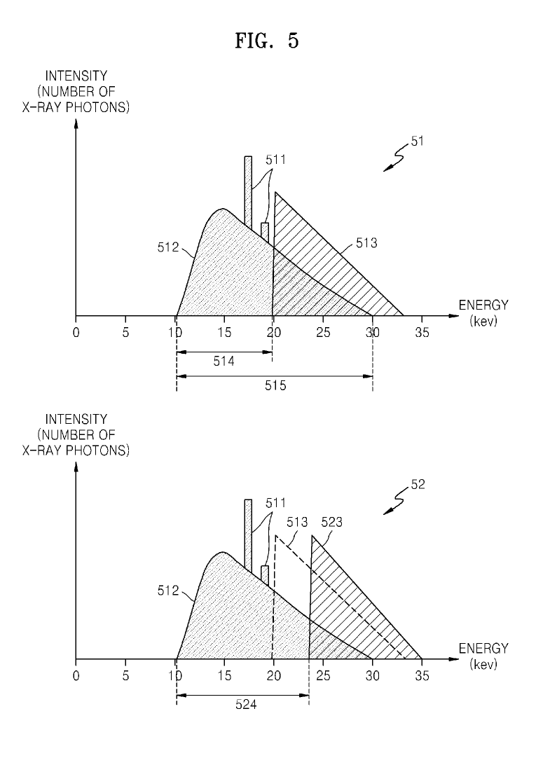

The component in the predetermined energy band, from among the radiation that is generated by the radiation generator 10 and passed through the subject 50, selectively passes through the unit filter 211. Assuming that the energy spectrum 11 of FIG. 2 is an energy spectrum of the radiation that passed through the subject 50, only the component in the band 114 from the energy spectrum 11 of the radiation that passed through the subject 50 may pass through the unit filter 211. Generally, the unit filter 211 may be formed of a material of a predetermined element so that the component in the predetermined energy band may selectively pass through the unit filter 211. The predetermined element may be selected based on an element for generating radiation generated by the radiation generator 10. An example of this will now be described with reference to FIG. 5.

FIG. 5 are graphs illustrating examples of energy spectrums 51 and 52 of the radiation generated from the radiation generator 10, and predetermined energy bands selected by the unit filter 211. The energy spectrum 51 may be an energy spectrum of radiation generated by the anode of the radiation generator 10, which is formed of molybdenum (Mo). However, Mo is an element arbitrarily selected for convenience of description, and various elements may be used to generate radiation. For example, chrome (Cr), iron (Fe), cobalt (Co), copper (Cu), silver (Ag), or tungsten (W) may be used to generate radiation. Further, elements may be combined to generate radiation.

Referring to FIGS. 3 and 5, the unit filter 211 may be formed by selecting an element such that the component in the predetermined energy band from the radiation that passed through the subject 50 may pass through the unit filter 211, while considering that Mo may be the element or may be included as one of the elements combined to generate radiation. For example, when the anode of the radiation generator 10 is formed of Mo, the unit filter 211 may also be formed of Mo. Referring to the energy spectrum 51, if the unit filter 211 is formed of Mo, a component in a predetermined energy band 514 from the radiation incident on the unit filter 211 may be determined by a filtering region 513 of the unit filter 211 formed of Mo. However, the unit filter 211 may be formed of a material other than or in addition to Mo. For example, referring to the energy spectrum 52, if the anode of the radiation generator 10 is formed of Mo, the unit filter 211 may be formed of rhodium (Rh). For example, a component in a predetermined energy band 524 from the radiation incident on the unit filter 211 may be determined by a filtering region 523 of the unit filter 211 formed of Rh. The unit filter 211 may be formed of a combination of a plurality of elements. As such, the material of the unit filter 211 is determined by considering the element for generating the radiation generated by the radiation generator 10.

The radiation that is generated by the radiation generator 10 and passed through the subject 50 without filtering passes through the space 212. Referring to FIG. 5, the radiation penetrating without filtering may mean that components of all energy bands 515 of the radiation that is generated by the radiation generator 10 and passed through the subject 50 may pass through the space 212.

An area of the unit filter 211 may be different from an area of the space 212. For example, the area of the unit filter 211 may be greater than the area of the space 212. In addition, such a difference between the area of the unit filter 211 and the area of the space 212 may correspond to a difference between an area of a unit sensor A 221 corresponding to the unit filter 211 and an area of a unit sensor B 222 corresponding to the space 212. Generally, the difference between the areas of the unit filter 211 and the space 212, and the difference between the areas of the respective unit sensors A and B 221 and 222 may be determined based on a difference between the intensity of a component in a predetermined energy band passing through the unit filter 211 and the intensity of a component in all energy bands passing through the space 212. For example, as the component in the predetermined energy band from the radiation that passed through the subject 50 passes through the unit filter 211, the intensity of the component is attenuated, whereas the intensity of the component in all energy bands that passes through the space 212 is not attenuated. Thus, in order to compensate for the attenuated intensity of the component in the predetermined energy band, the areas of the unit sensor A 221 receiving the component in the predetermined energy band and the unit filter 211 corresponding to the unit sensor A 221 may be respectively greater than the areas of the unit sensor B 222 receiving the component in all energy bands and the space 212 corresponding to the unit sensor B 222.

A thickness of the unit filter 211 may be determined by considering the characteristics of the component in the predetermined energy band from the radiation that passed through the subject 50. Generally, the thickness of the unit filter 211 may determine the intensity or actual energy band of the component in the predetermined energy band. For example, the thickness of the unit filter 211 may be a factor that determines an absorption coefficient of the unit filter 211 together with the type of the material forming the unit filter 211. In addition, the absorption coefficient may determine the intensity or the actual energy band of the component that has selectively passed through the unit filter 211.

The sensor unit 22 includes a plurality of unit sensors disposed below the filter unit 21. Generally, the sensor unit 22 detects the radiation signals from the component that passes through the unit filter 211 and the component that passes through the space 212. Referring to FIG. 3, the sensor unit 22 includes the unit sensors and a radiation signal detector 223. The unit sensor A 221 from among the unit sensors may receive the component in the predetermined energy band that selectively passes through by the unit filter 211, generate an electric signal from the component in the predetermined energy band, and transmit the electric signal to the radiation signal detector 223. The unit sensor B 222 from among the unit sensors may receive the component that passes through the space 212, generate an electric signal from the component, and transmit the electric signal to the radiation signal detector 223. As such, the unit sensor A 221 and the unit sensor B 222 may receive the component in the predetermined energy band or the component in all energy bands, respectively, and generate an electric signal corresponding to the component received. The unit sensor A 221 may include a photodiode.

The radiation signal detector 223 detects the radiation signals by using the electric signals received from the unit sensors. Generally, the unit sensors may be arranged in a 1D, 2D, or 3D array, and the radiation signal detector 223 may detect the radiation signal by combining the electric signals received from the unit sensors. For example, each of the electric signals from the unit sensors may have a size corresponding to the intensity of the received radiation. The radiation signal detector 223 may detect the radiation signals by using a difference between the sizes of the electric signals. The radiation signal detector 223 detects the radiation signal by using the electric signals received from at least one unit sensor A 221, and detects the radiation signal by using the electric signals received from at least one unit sensor B 222. Generally, the radiation signal detector 223 may be formed of one or more processors for detecting the radiation signal from the electric signals. A processor may be realized in an array of logic gates, or in a combination of a general-purpose microprocessor and a memory storing a program executable by the general-purpose microprocessor. However, the processor may be realized in a different form of hardware.

The area of the unit sensor A 221 may be different from the area of the unit sensor B 222. For example, the component in the predetermined energy band may be input to a side of the unit sensor A 221, and an area of the side of the unit sensor A 221 may be different from an area of a side of the unit sensor B 222 to which the component in all energy bands is input. Generally, the intensity of the radiation that passes through the unit filter 211 may be attenuated compared to the intensity of the radiation before passing through the unit filter 211. For example, as described above, the intensity of radiation may denote the number of photons in the radiation. Accordingly, the intensity of the component that passes through the unit filter 211 and the intensity of the component that passes through the space 212 may be different from each other. Such a difference may generate a distinction between a radiation image generated from radiation having the intensity that is not attenuated, and a radiation image generated from radiation having the intensity that is attenuated. Accordingly, the difference between the intensities of the component that passes through the unit filter 211 and the component that passes through the space 212 may need to be lessened. Accordingly, the area of the side of the unit sensor A 221 may be configured to be greater than that of the unit sensor B 222. In other words, the unit sensor A 221 may have a greater area than the unit sensor B 222, thereby compensating for the intensity of the component in the predetermined energy band, which is attenuated by passing through the unit filter 211.

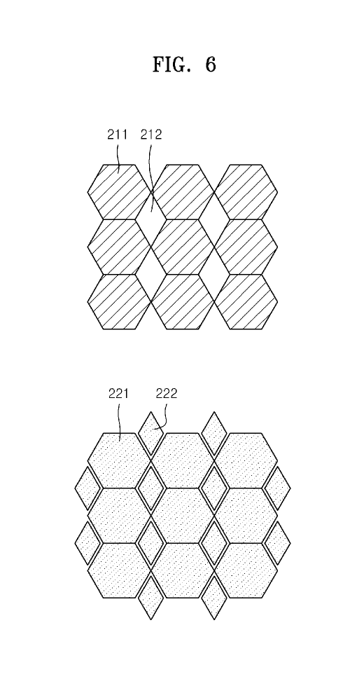

FIG. 6 is diagrams illustrating examples of the unit filter 211, the space 212, the unit sensor A 221, and the unit sensor B 222. Referring to FIG. 6, the filter unit 21 (illustrated in FIG. 3) may include unit filters as the unit filter 211, and spaces as the space 212. In addition, shapes of the unit filter 211 and the space 212 may be respectively identical to those of the unit sensor A 221 and the unit sensor B 222. For example, since one side of the unit filter 211 receives radiation that passes through the subject 50, only the component in the predetermined energy band may selectively pass through another side of the unit filter 211, and the unit sensor A 221 may receive the component in the predetermined energy band, wherein a shape of the one or other side of the unit filter 211 may be identical to a shape of the side of the unit sensor A 221. If shapes of the sides of the unit filter 211 and the unit sensor A 221 are the same, areas of the sides of the unit filter 211 and the unit sensor A 221 may be the same. Thus, the shape of the space 212 may be identical to the shape of the side of the unit sensor B 222. However, the unit filter 211, the space 212, the unit sensor A 221, and the unit sensor B 222 of FIG. 6 are only examples, and may be differently configured.

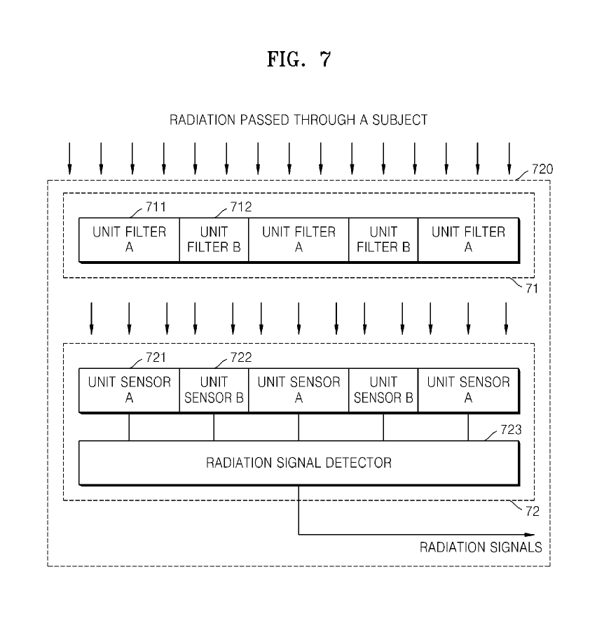

FIG. 7 is a diagram illustrating an example of a radiation signal detection apparatus 720. Referring to FIG. 7, the radiation signal detection apparatus 720 includes a filter unit 71 and a sensor unit 72. However, the radiation signal detection apparatus 720 of FIG. 7 is only an example, and may be modified based on the elements of FIG. 7.

The filter unit 71 includes unit filters. The filter unit 71 includes a unit filter A 711 through which only a component in a predetermined energy band from the radiation passed through the subject 50 selectively passes, and a unit filter B 712 through which only a component in a different energy band from the predetermined energy band selectively passes. In addition, the components in the predetermined energy band and the different energy band may be generated from a difference between materials for forming the unit filter A 711 and the unit filter B 712. Each of the materials for forming the unit filter A 711 and the unit filter B 712 may be selected by considering an element for generating the radiation generated by the radiation generator 10.

Referring to FIGS. 5 and 7, if the anode of the radiation generator 10 is formed of Mo, the unit filter A 711 may be formed of Mo, and the unit filter B 712 may be formed of Rh while considering the material of the anode. For example, the component in the predetermined energy band 514 from the radiation incident on the unit filter A 711 may be determined by the filtering region 513 of the unit filter A 711 formed of Mo, and the component in the predetermined energy band 524 from the radiation incident on the unit filter B 712 may be determined by the predetermined filtering region 523 of the unit filter B 712 formed of Rh. Accordingly, the component in the predetermined energy band 514 filtered by the unit filter A 711 and the component in the predetermined energy band 524 filtered by the unit filter B 712 are different from each other. However, the unit filter A 711 formed of Mo and the unit filter B 712 formed of Rh by considering that the anode of the radiation generator 10 formed of Mo is only an example, and the materials of the unit filters A and B 711 and 712, and the material of the anode may differ.

In addition, an area of the unit filter A 711 may be different from an area of the unit filter B 712. Referring to FIG. 7, the area of the unit filter A 711 is greater than the area of the unit filter B 712, but the area of the unit filter B 712 may be greater than or equal to the area of the unit filter A 711. Generally, a difference between the areas of unit filters A and B 711 and 712 corresponds to a difference between areas of a unit sensor A 721 corresponding to the unit filter A 711 and a unit sensor B 722 corresponding to the unit filter B 712. Also, the differences between the areas of the unit filters A and B 711 and 712 and between the areas of the unit sensors A and B 721 and 722 may be determined from a difference between the intensity of the component in the predetermined energy band that passes through the unit filter A 711 and the intensity of the component in the different energy band that passes through the unit filter B 712. For example, when the intensity of the component in the predetermined energy band is attenuated as the component passes through the unit filter A 711, and the intensity of the component in the different energy band is attenuated as the component passes through the unit filter B, an attenuation degree of the intensity of the component in the predetermined energy band is different from an attenuation degree of the intensity of the component in the different energy band. In order to compensate for the difference between the intensities, the areas of the unit filters and the areas of the unit sensors corresponding to the unit filters may be configured to be different from each other. Referring to FIG. 7, since the attenuation degree of the intensity of the component in the predetermined energy band is greater than the attenuation degree of the intensity of the component in the different energy band, the area of the unit filter A 711 may be configured to be greater than the area of the unit filter B 712, and the area of the unit sensor A 721 may be configured to be greater than the area of the unit sensor B 722 in the same context.

Generally, the difference between the intensities of the components in the predetermined energy band and the different energy band is dependent on a difference between characteristics of the unit filter A 711 and the unit filter B 712. The difference between the characteristics of the unit filters A and B 711 and 712 may be a difference between materials of the unit filters A and B 711 and 712, and between thicknesses of the unit filters A and B 711 and 712. However, the difference between characteristics of the unit filters A and B 711 and 712 is not limited to the difference between the materials or thicknesses.

The thickness of the unit filter A 711 may be determined by considering the characteristics of the component in the predetermined energy band. Generally, the thickness of the unit filter A 711 determines the intensity or actual energy band of the component of the predetermined energy band. For example, the thickness of the unit filter A 711 is a factor in a determination of an absorption coefficient of the unit filter A 711, along with the type of the material of the unit filter A 711. In addition, the absorption coefficient may determine the intensity or the actual energy band of the component that selectively penetrates through the unit filter A 711. Thus, the thickness of the unit filter B 712 may be determined by considering the characteristics of the component in the different energy band.

The sensor unit 72 includes a plurality of unit sensors disposed below the filter unit 71. Generally, the sensor unit 72 detects radiation signals from the component that passes through the unit filter A 711 and the component that passes through the unit filter B 712. Referring to FIG. 7, the sensor unit 72 includes the unit sensors and a radiation signal detector 723. A unit sensor A 721 from among the unit sensors may receive the component in the predetermined energy band that selectively passes through the unit filter A 711, generate an electric signal from the component in the predetermined energy band, and transmit the electric signal to the radiation signal detector 723. A unit sensor B 722 from among the unit sensors may receive the component in the different energy band that passes through the unit filter B 712, generate an electric signal from the component in the different energy band, and transmit the electric signal to the radiation signal detector 723. As such, each of the unit sensors A and B 721 and 722 may receive the component in the predetermined energy band or the different energy band, and generate an electric signal corresponding to the received component. An example of the unit sensors A and B 721 and 722 is a photodiode.

The radiation signal detector 723 detects the radiation signals by using the electric signals received from the unit sensors. Generally, the unit sensors may be arranged in a 1D, 2D, or 3D array, and the radiation signal detector 723 detects the radiation signals by combining the electric signals received from the unit sensors. For example, the sizes of the electric signals of the unit sensors may respectively correspond to the intensities of the radiation input to the unit sensors. The radiation signal detector 723 may detect the radiation signal by using a difference between the sizes of the electric signals. In this context, the radiation signal detector 723 detects a radiation signal by using the electric signals received from at least one unit filter A, and detects a radiation signal by using the electric signals from the unit filter B. Generally, the radiation signal detector 723 may be formed of one or more processors for detecting the radiation signals from the electric signals. A processor may be realized in an array of logic gates, or in a combination of a general-purpose microprocessor and a memory storing a program executable by the general-purpose microprocessor. However, the processor may be realized in a different form of hardware.

The area of the unit sensor A 721 may be different from the area of the unit sensor B 722. As described above, such a difference between the areas is determined by the difference between the intensities of the component that passes through the unit filter A 711 and the component that passes through the unit filter B 712. Such a difference generates a difference between a radiation image generated from the radiation signal detected by the unit sensor A 721 and a radiation image generated from the radiation signal detected by the unit sensor B 722. Accordingly, the difference between the intensities of the component that passes through the unit filter A 711 and the component that passes through the unit filter B 712 needs to be lessened. Accordingly, the area of the unit sensor A 721 is configured to be different from the area of the unit sensor B 722, thereby compensating for the difference between the intensities of the component that passes through the unit filter A 711 and the component that passes through the unit filter B 712.

Details that have not been described in FIG. 7 are easily inferred by one of ordinary skill in the art based on the details of FIGS. 1 through 6, and thus are not repeated herein.

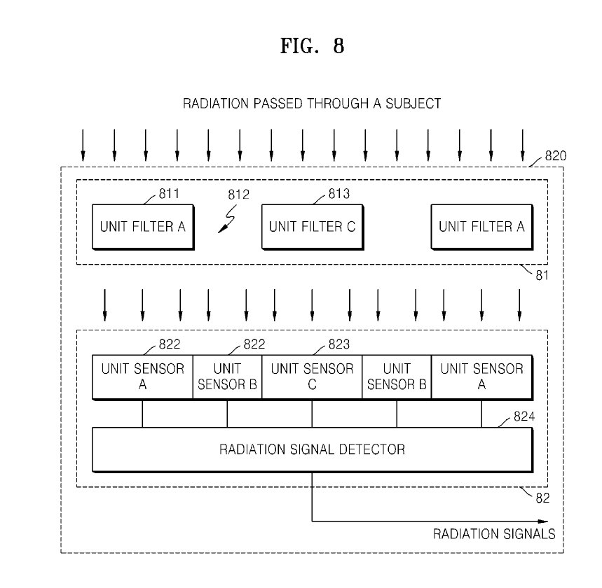

FIG. 8 is a diagram illustrating an example of a radiation signal detection apparatus 820. Referring to FIG. 8, the radiation signal detection apparatus 820 includes a filter unit 81 and a sensor unit 82. However, the radiation signal detection apparatus 820 of FIG. 8 is only an example, and it would be obvious to one of ordinary skill in the art that the radiation signal detection apparatus 820 may be modified based on the elements of FIG. 8.

The filter unit 81 includes unit filters. The filter unit 81 includes a unit filter A 811 through which only a component in a predetermined energy band from the radiation that passed through the subject 50 selectively passes through, and a unit filter C 813 through which a component in a different energy band from the predetermined energy band selectively passes through. For example, components in the predetermined energy band and in the different energy band may be generated from a difference between materials for forming the unit filters A and C 811 and 813. In addition, the materials for forming the unit filters A and C 811 and 813 may be each selected by considering the element for generating the radiation generated by the radiation generator 10. For example, when the anode of the radiation generator 10 is formed of Mo, the unit filter A 811 may be formed of Mo and the unit filter C 813 may be formed of Rh by considering the material of the anode. However, the unit filter A 811 formed of Mo and the unit filter C 813 formed of Rh by considering the anode formed of Mo are only an example, and materials of the unit filters A and C 811 and 813, and the material of the anode may differ.

The filter unit 81 includes a space 812 between the unit filters that are the unit filter A 811 and the unit filter C 813. Accordingly, the component in the predetermined energy band of radiation generated by the radiation generator 10 and passed through the subject 50 selectively passes through the unit filter A 811, the component in the different energy band selectively passes through the unit filter C 813, and a component in all energy bands passes through the space 812. FIG. 8 is a diagram illustrating an example of the filter unit 81 and the sensor unit 82. As shown in FIG. 8, the filter unit 81 may include the unit filters such as the unit filter A 811 and the unit filter C 813, and spaces as the space 812. However, the filter unit 81 of FIG. 8 is only an example, and it would be obvious to one of ordinary skill in the art that the structure of the filter unit 81 including the unit filters and spaces may differ.

Only the component in the predetermined energy band from radiation that is generated by the radiation generator 10 and passed through the subject 50 selectively passes through the unit filter A 811. Only the component in the different energy band from the radiation that is generated by the radiation generator 10 and passed through the subject 50 selectively passes through the unit filter C 813. The radiation that is generated by the radiation generator 10 and passed through the subject 50 without filtering passes through the space 812.

In addition, an area of the unit filter A 811 may be different from an area of the space 812. In addition, the area of the unit filter A 811 may be different from an area of the unit filter C 813. Generally, a difference between the areas of the unit filters may correspond to a difference between areas of a unit sensor A 821 corresponding to the unit filter A 811, a unit sensor B 822 corresponding to the space 812, and a unit sensor C 823 corresponding to the unit filter C 813. Also, the differences between the areas of the unit filters and between the areas of the unit sensors may be determined based on a difference between at least two of the intensity of the component in the predetermined energy band that passes through the unit filter A 811, the intensity of the component in all energy bands that pass through the space 812, and the intensity of the component in the different energy band that passes through the unit filter C 813.

A thickness of the unit filter A 811 may be determined by considering the characteristics of the component in the predetermined energy band from radiation that passes through the subject 50. Generally, the thickness of the unit filter A 811 determines intensity or actual energy band of the component in the predetermined energy band. For example, the thickness of the unit filter A 811 is a factor for determining an absorption coefficient of the unit filter A 811, together with the type of the material for forming the unit filter A 811. The absorption coefficient may determine the intensity or actual energy band of the component that has selectively passed through the unit filter A 811. In this aspect, a thickness of the unit filter C 813 may be determined by considering the characteristics of the component in the different energy band from radiation that passes through the subject 50.

The sensor unit 82 includes a plurality of unit sensors disposed below the filter unit 81. Generally, the sensor unit 82 detects radiation signals from the component that passed through the unit filter A 811, the component that passed through the space 812, and the component that passed through the unit filter C 813. Referring to FIG. 8, the sensor unit 82 includes the unit sensors and may include a radiation signal detector 824.

The unit sensor A 821 from among the unit sensors may receive the component in the predetermined energy band that selectively passes through the unit filter A 811, generate an electric signal from the component in the predetermined energy band, and transmit the electric signal to the radiation signal detector 824. Meanwhile, the unit sensor B 822 from among the unit sensors may receive the component in all energy bands that pass through the space 812, generate an electric signal from the component in all energy bands, and transmit the electric signal to the radiation signal detector 824. In addition, the unit sensor C 823 from among the unit sensors may receive the component in the different energy band that selectively passes through the unit filter C 813, generate an electric signal from the component in the different energy band, and transmit the electric signal to the radiation signal detector 824. The radiation signal detector 824 detects radiation signals by using the electric signals received from the unit sensors. The radiation signal detector 824 may be formed of one or more processors for detecting the radiation signals from the electric signals.

At least two of the area of the unit sensor A 821, the area of the unit sensor B 822, and the area of the unit sensor C 823 are different from each other. As described above, such a difference is due to a difference between at least two of the intensity of the component that passes through the unit filter A 811, the intensity of the component that passes through the space 812, and the intensity of the component that passes through the unit filter C 813.

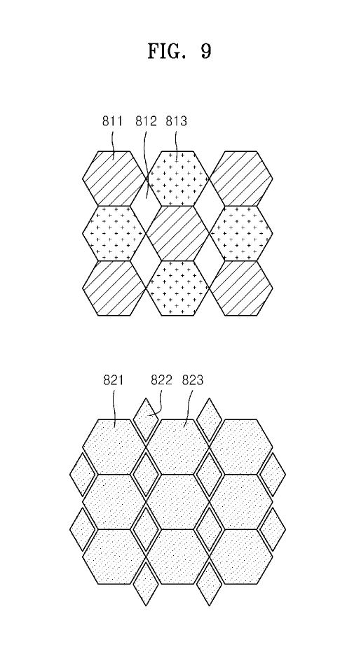

FIG. 9 are diagrams illustrating examples of the unit filter A 811, the space 812, the unit filter C 813, the unit sensor A 821, the unit sensor B 822, and the unit sensor C 823. Referring to FIG. 9, the filter unit 81 of FIG. 8 may include the unit filters such as the unit filter A 811 and the unit filter C 813, and the spaces including the space 812. In addition, shapes of the unit filter A 811, the space 812, and the unit filter C 813 may be respectively identical to the unit sensor A 821, the unit sensor B 822, and the unit sensor C 823. For example, since one side of the unit filter A 811 receives radiation that passes through the subject 50, only the component in the predetermined energy band may selectively pass through another side of the unit filter A 811, and the unit sensor A 821 may receive such a component in the predetermined energy band, wherein a shape of the one or other side of the unit filter A 811 is identical to one side of the unit sensor A 821. In other words, an area of the one side of the unit filter A 811 is identical to an area of the one side of the unit sensor A 821. In this aspect, the area of the space 812 may be identical to the area of the one side of the unit sensor B 822, and the area of the unit filter C 813 may be identical to the area of the one side of the unit sensor C 823. However, the unit filter A 811, the space 812, the unit filter C 813, the unit sensor A 821, the unit sensor B 822, and the unit sensor C 823 of FIG. 9 are only examples, and may differ.

Details that have not been described in FIGS. 8 and 9 are easily inferred by one of ordinary skill in the art based on the details of FIGS. 1 through 7, and thus are not repeated herein.

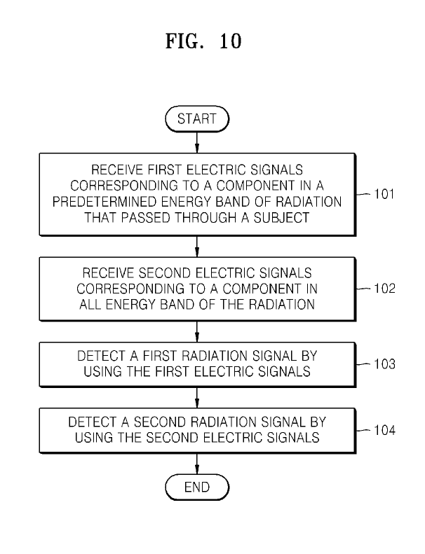

FIG. 10 is a flowchart illustrating an example of a method of detecting radiation signals. The method of FIG. 10 includes operations processed in time-series by the radiation signal detection apparatus 20 of FIG. 3, the radiation signal detection apparatus 720 of FIG. 7, or the radiation signal detection apparatus 820 of FIG. 8. Accordingly, details that have not been described in FIG. 10 are easily inferred by one of ordinary skill in the art based on the details about the radiation signal detection apparatus 20, and thus, are not repeated herein.

In operation 101, the radiation signal detector 223 receives electric signals corresponding to the component in the predetermined energy band of the radiation from first unit sensors. In operation 102, the radiation signal detector 223 receives different electric signals corresponding to the component in the different energy band of the radiation from second unit sensors. In operation 103, the radiation signal detector 223 detects a radiation signal by using the electric signals. In operation 104, the radiation signal detector 223 detects another radiation signal having characteristics different from the radiation signal of operation 103, by using the different electric signals.

According to teachings above, there is provided a radiation signal detection apparatus and a method of detecting radiation signals from radiations in different energy bands that may be capable of outputting a high resolution radiation image by using radiation signals having different characteristics, thereby enabling a medical expert to accurately diagnose a disease and minimize a misdiagnosis.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. In addition, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. In addition, the described apparatus to perform an operation or a method may be hardware, software, or some combination of hardware and software. For example, the apparatus may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A radiation signal detection apparatus, comprising:
a filter unit configured to allow penetration of a component of radiation that passed through a subject, the filter unit comprising one or more unit filters configured to allow penetration of only a component in a predetermined energy band of the radiation; and
a sensor unit, comprising:
one or more first unit sensors configured to convert only the component of the radiation for which the penetration is allowed by the unit filters into a first electric signal;
one or more second unit sensors configured to convert a component in all energy bands of the radiation into a second electric signal; and
a radiation signal detector configured to detect a first radiation signal and a second radiation signal by respectively using the first electric signal of the first unit sensors and the second electric signal of the second unit sensors.

2. The apparatus of claim 1, wherein the first radiation signal has characteristics that differ from characteristics of the second radiation signal.

3. The apparatus of claim 1, wherein a light-receiving area of the first unit sensors is greater than a light-receiving area of the second unit sensors.

4. The apparatus of claim 1, wherein the unit filters are arranged such that spaces are formed throughout the filter unit, the spaces allowing the penetration of the radiation from which the second radiation signal is detected.

5. The apparatus of claim 1, wherein:
the filter unit further comprises one or more other unit filters, each of the other unit filters being configured to allow penetration of only a component in an other predetermined energy band of the radiation;
the sensor unit further comprises one or more third unit sensors configured to convert only the component of the radiation for which the penetration is allowed by the other unit filters into a third electric signal; and
the radiation signal detector is further configured to detect a third radiation signal using the third electric signal of the third unit sensors.

6. The apparatus of claim 5, wherein the other predetermined energy band differs from the predetermined energy band.

7. The apparatus of claim 5, wherein the third radiation signal has characteristics that differ from the characteristics of the first radiation signal and the second radiation signal.

8. The apparatus of claim 5, wherein the unit filters and the other unit filters are arranged such that spaces are formed throughout the filter unit, the spaces allowing the penetration of the radiation from which the second radiation signal is detected.

9. The apparatus of claim 5, wherein a material that forms the unit filters differs from a material that forms the other unit filters.

10. The apparatus of claim 5, wherein a thickness of the unit filters is greater than a thickness of the other unit filters.

11. A radiation signal detection apparatus, comprising:
a filter unit, comprising:
one or more first unit filters configured to allow penetration of only a first component, the first component being in a predetermined energy band of radiation that passed through a subject; and
one of more second unit filters configured to allow penetration of only a second component, the second component being in a different energy band of the radiation from the predetermined energy band; and
a sensor unit, comprising:
one or more first unit sensors configured to convert only the component of the radiation for which the penetration is allowed by the first unit filters into a first electric signal;
one or more second unit sensors configured to convert only the component of the radiation for which the penetration is allowed by the second unit filters into a second electric signal; and
a radiation signal detector configured to detect a first radiation signal and a second radiation signal by respectively using the first electric signal of the first unit sensors and the second electric signal of the second unit sensors.

12. The apparatus of claim 11, wherein the first radiation signal has characteristics that differ from characteristics of the second radiation signal.

13. The apparatus of claim 11, wherein a light-receiving area of the first unit sensors is greater than a light-receiving area of the second unit sensors.

14. The apparatus of claim 11, wherein a material that forms the first unit filters differs from a material that forms the second unit filters.

15. The apparatus of claim 11, wherein a thickness of the first unit filters is greater than a thickness of the second unit filters.

16. A method of detecting radiation signals, the method comprising:
receiving one or more first electric signals output from one or more first unit sensors, the first electric signals corresponding to a component in a predetermined energy band of radiation that passed through a subject;
receiving one or more second electric signals output from one or more second unit sensors, the second electric signals corresponding to a component in all energy bands of the radiation;
detecting a first radiation signal by using the first electric signals; and
detecting a second radiation signal by using the second electric signals.

17. The method of claim 16, wherein a light-receiving area of the first unit sensors is greater than a light-receiving area of the second unit sensors.

18. The method of claim 16, further comprising:
receiving one or more third electric signals output from one or more third unit sensors, the third electric signals corresponding to a component in an other energy band of the radiation, the other energy band of the radiation being different from the predetermined energy band of the radiation; and
detecting a third radiation signal by using the third electric signals.

19. A method of detecting radiation signals, the method comprising:
receiving one or more first electric signals output from one or more first unit sensors, the first electric signals corresponding to a component in a first energy band of radiation that passed through a subject;
receiving one or more second electric signals output from one or more second unit sensors, the second electric signals corresponding to a component in a second energy band of the radiation, the second energy band being different from the first energy band;
detecting a first radiation signal by using the first electric signals; and
detecting a second radiation signal by using the second electric signals.

20. The method of claim 19, wherein a light-receiving area of the first unit sensors is greater than a light-receiving area of the second unit sensors.
